(19) United States
(12) Patent Application Publication
(10) Pub. No.: US 2026/0042329 A1
(43) Pub. Date: Feb. 12, 2026

(54) LANDING GEAR SAFETY SYSTEM, AND COMPONENTS THEREFOR

(71) Applicants: Daniel Schwarz, Wyoming, MI (US); Henry Schwarz, Grand Rapids, MI (US)

(72) Inventors: Daniel Schwarz, Wyoming, MI (US); Henry Schwarz, Grand Rapids, MI (US)

(21) Appl. No.: 19/291,762

(22) Filed: Aug. 6, 2025

Related U.S. Application Data
(60) Provisional application No. 63/681,847, filed on Aug. 11, 2024.

(51) Int. Cl. B60D 1/64; B60D 1/36

(52) U.S. Cl. CPC B60D 1/64; B60D 1/36

(57) ABSTRACT

A landing gear safety system for preventing vehicle damage caused by unsafe extended or retracted positions of a semi-trailer landing gear. The safety system operates by monitoring safety conditions on the towed portion of the vehicle. When the safety conditions are met, a disconnect function is enabled on a coupler, such as a fifth wheel. When the safety conditions are not met, a coupler disconnect function is disabled and, optionally, the vehicle operator is alerted to the unsafe configuration of the vehicle.

### TECHNICAL FIELD

The present invention related to transportation safety and more particularly to a safety system used with landing gear used with a semi-trailer truck and/or tractor trailer.

### BACKGROUND

The operation of connecting and disconnecting a trailer to a semi-truck can be dangerous. The improper disconnection of the towed portion, such as a trailer, from the pulling portion of a truck, tractor and/or other vehicle can often result in costly damage. The towed portion is prone to damage when the landing gear is not extended during separation, especially when fully loaded. For example, when a fully loaded towed portion, such as a trailer, falls to the ground during separation with the landing gear retracted, the landing gear can collapse under the impact. In recent years, the introduction of pneumatically actuated fifth wheels to the market has increased the likelihood that the exemplified damage mode may occur. An example of a safety system for use with a pneumatically actuated fifth wheel is described in U.S. Pat. No. 12,059,935, owned by Applicant, which is incorporated by reference herein in its entirety.

Pneumatically actuated fifth wheels provide the benefit of eliminating the 60-100 lbs. strain to the vehicle operator's shoulder that occurs when disconnecting a towed portion's kingpin from a lever actuated fifth wheel. Pneumatic actuation allows the vehicle operator to disconnect the pulling portion from the towed portion while remaining inside the cab instead of exiting the cab to pull a kingpin release lever on the fifth wheel. The greatest drawback of pneumatically actuated fifth wheels is the removal of the vehicle operator from the process of disconnecting the kingpin. While the vehicle operator is in the cab of the pulling portion, they are unable to inspect the safety conditions of both vehicle portions while the kingpin is being released.

Unsafe conditions may also exist when the towed portion is connected to the pulling portion and the vehicle is in motion. The towed portion is prone to damage when the vehicle is operated with the landing gear extended. For example, a towed portion with partially extended landing gear, such as a trailer, may strike the gear on obstacles like railroad tracks or curbs when the vehicle is in motion, causing excessive loads on the landing gear and drive train of the vehicle. Thus, new solutions are required to safely allow the operator to both connect and disconnect the trailer from the vehicle while remaining in the cab.

### BRIEF DESCRIPTION OF THE DRAWINGS

FIG. 1 is an isometric view of a single landing gear leg in its fully retracted position with safety system that measures leg extension using a circular measurement scale;

FIG. 2 is an isometric view of the single landing gear leg of FIG. 1 with the housing components made to be transparent to display a discrete sensor and a discrete circular measurement scale;

FIG. 3 is a diagram of a discrete sensor and a discrete circular measurement scale utilizing magnetism as the operative sensing mechanism;

FIG. 4 is a diagram of a pair of discrete sensors and a discrete circular measurement scale utilizing magnetism as the operative sensing mechanism;

FIG. 5 is a diagram of a continuous variable sensor and a continuous variable circular measurement scale utilizing magnetism as the operative sensing mechanism;

FIG. 6 is an isometric view of a single landing gear leg in its fully retracted position with a safety system that measures leg extension using a linear measurement scale;

FIG. 7 is cross-sectional view of the linear measurement apparatus of FIG. 6;

FIG. 8 is an enlarged view of the upper portion of FIG. 7;

FIG. 9 is an enlarged view of the center portion of FIG. 7;

FIG. 10 is an enlarged view of the lower portion of FIG. 7;

FIG. 11 is a diagram of a discrete sensor and a discrete linear measurement scale utilizing magnetism as the operative sensing mechanism;

FIG. 12 is a diagram of a continuous variable sensor and a continuous variable linear measurement scale utilizing magnetism as the operative sensing mechanism; and

FIG. 13 is a functional block diagram of a pulling vehicle with a safety system that measures the extension of the landing gear using a circular measurement scale and two discrete sensors;

FIG. 14 is a flow chart describing the safety system control process for measuring landing gear extension during the separation of the pulling portion of a vehicle from the towed portion; and

FIG. 15 is a flow chart describing the safety system control process for measuring landing gear extension during vehicle movement.

### DETAILED DESCRIPTION

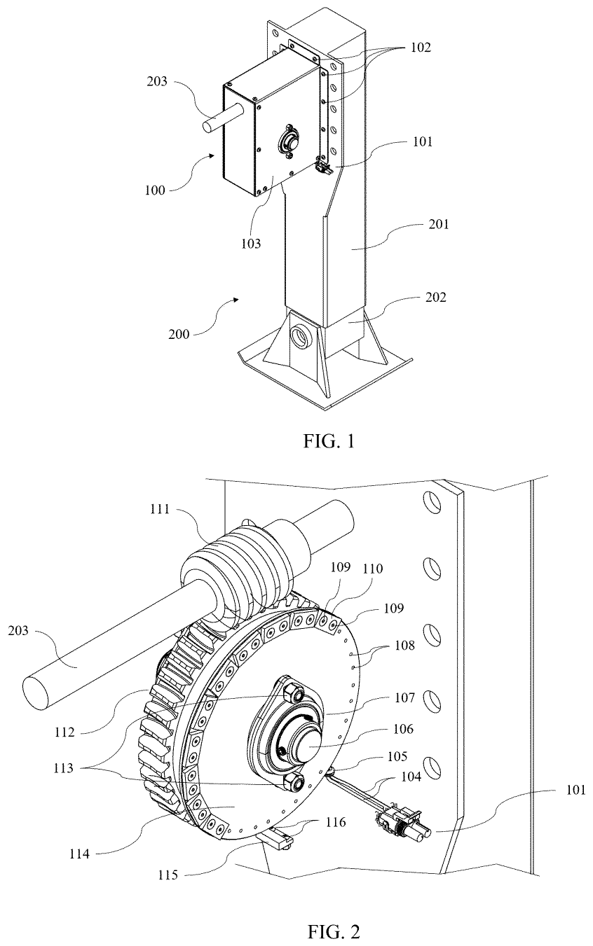

Referring to FIG. 1, the numeral 100 generally designates a safety system for detecting the extended or retracted state of a landing gear 200, for a vehicle with a pulling portion and a towed portion, such as a commercial tractor and trailer. As will be more fully described below, the safety system 100 is configured to monitor the status of the landing gear 200 and confirm its safe deployment prior to disconnecting the towed portion from the pulling portion of the vehicle.

FIG. 1, shows an embodiment of safety system 100 installed on a landing gear 200 assembly. The landing gear 200 consists of two coaxial tubes where the upper tube 201 is fixed to the frame of the towed portion of the vehicle (not shown) and the lower tube 202 moves up and down when the vehicle operator raises or lowers the landing gear 200. Although the term “vehicle” is used throughout the specification, those skilled in the art will recognize that this term may include any type of motorized machine for transporting people and cargo, including but not limited to trucks, tractors, pulling vehicles, pulling portions and/or fifth wheel vehicles. Similarly, the term “trailer” means any unpowered vehicle towed by another which may include semi-trailers, RV trailers, farm implements and the like.

As seen in FIG. 1, the landing gear has an output shaft 203 that rotates in direct proportion to the extension or retraction of the landing gear 200. Output shaft 203 may be connected to another landing gear 200 assembly such that both landing gear 200 assemblies extend or retract in unison. The safety system 100 utilizes this proportional relationship to sense the extended or retracted state of the landing gear 200 and transmits a corresponding signal to an electrical connector 101. The safety system 100 is mounted to the upper tube 201 of the landing gear 200 by a series of screws 102 and the output shaft 203 passes through the housing 103. Thus, the single landing gear leg shown in FIG. 1 is in a fully retracted position where the safety system will measure leg extension using a circular measurement scale. The circular measurement scale rotates in proportion to the linear extension of landing gear such that one or more discrete sensor(s) detects a fixed polarity magnetic signal for measuring the landing gear position.

FIG. 2 illustrates the internal components of the safety system 100 with the housing 103 made to be transparent. The housing 103 supports a pair of bearings 107 whose axis of rotation is oriented perpendicular to the output shaft's 203 axis of rotation. The bearings 107 are fastened to the housing 103 by carriage bolts 113 and the bearings 107 support the rotation of an idler shaft 106 and a worm gear 112 which rotates with the idler shaft 106. The worm gear 112 is driven by a worm 111 that rotates with the output shaft 203 of the landing gear 200. A magnet wheel 114 rotates with the worm gear 112 and idler shaft 106 such that one full revolution is completed between the fully extended and fully retracted positions of the landing gear 200. The perimeter of the magnet wheel 114 has a series of mounting holes 108 for fastening magnets 110 with screws 109. The magnets 110 are arranged on the magnet wheel 114 such that a sensor 115 detects the magnets when the landing gear 200 is extended sufficiently for safe decoupling of the towed portion from the pulling portion of the vehicle. The sensor 115 is fastened to the housing 103 by a pair of screws 116 and two wires 104 from the sensor 115 are routed outside the housing 103 by a grommet 105 to an electrical connector 101.

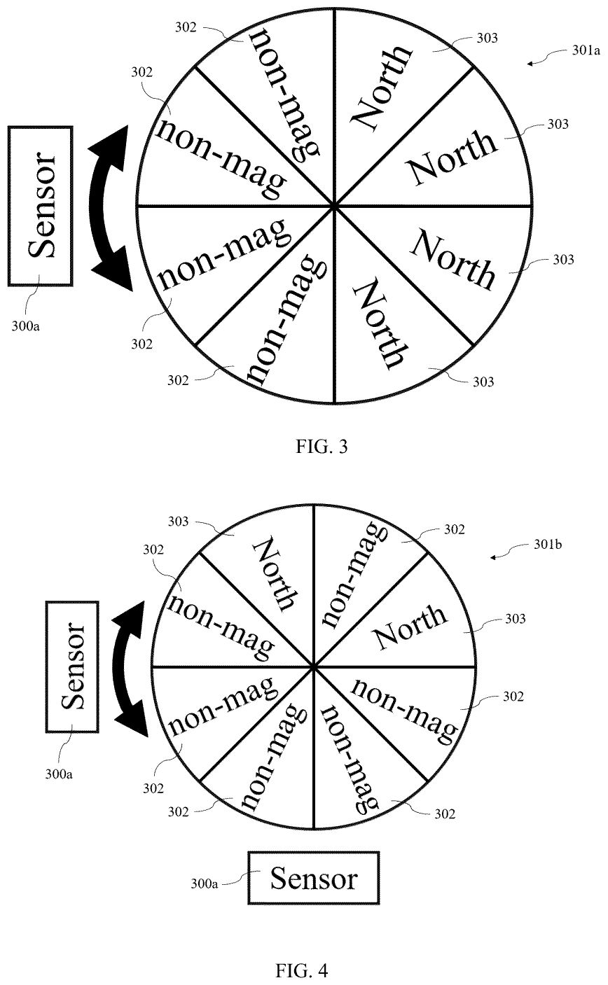

FIG. 3 illustrates a method of discrete sensing used by the safety system 100. A discrete sensor 300a, such as a reed switch, may be used to detect a fixed polarity magnetic signal produced by the north polarity magnetic region 303. The magnetic scale 301a rotates in proportion to the extension of the landing gear 200 such that one full revolution of the magnetic scale 301a is achieved between the fully retracted position and the fully extended position of the landing gear 200. The magnetic scale 301a has a non-magnetic region 302 indicating one state of either extension or retraction of the landing gear 200 and a north polarity magnetic region 303 indicating the opposite state. The north polarity magnetic region 303 may be increased or decreased in size by removing or adding segments to the north polarity magnetic region 303 and may also be shifted about the axis to achieve different transition points between the two discrete states of the landing gear 200 extension or retraction. Thus, in FIG. 3, a first half of the circular measurement scale 301 is magnetic and a second half of the circular measurement scale 301 is non-magnetic. The discrete magnetic scale will not rotate by more than one full revolution so that the state indicators do not repeat. However, those skilled in the art will recognize that it is possible the discrete magnetic scale can rotate less than one full revolution depending on the gearing used.

FIG. 4 illustrates an alternative sensing method for the safety system 100. A pair of discrete sensors 300a, such as reed switches, may be used to detect a fixed polarity magnetic signal produced by the north polarity magnetic region 303. The magnetic scale 301b rotates in proportion to the extension of the landing gear 200 such that one half of a full revolution of the magnetic scale 301b is achieved between the fully retracted position and the fully extended position of the landing gear 200. The north polarity magnetic region 303 is divided into two distinct portions of the scale such that the first portion of the north polarity magnetic region 303 passes in front of the first discrete sensor 300a when the landing gear is retracted and the second portion of the north polarity magnetic region 303 passes in front of the second discrete sensor 300a when the landing gear 200 is extended. As noted above, one half a revolution can also be replaced with other potential proportions depending on gear ratios used and magnet positions on the scale.

In use, a first portion of a magnetic region on the circular measurement scale passes in front of a first discrete sensor when the landing gear is retracted and a second portion of the magnetic region passes in front of a second discrete sensor when the landing gear is extended.

The safety system detects landing gear transitioning from extended to a retracted position when a non-magnetic region passes in front of the first discrete sensor and second discrete sensor. The safety system indicates when the landing gear has been extended sufficiently for a semi-trailer to be safely released and/or moved from the pulling vehicle. The safety system can also prevent release by controlling operation of a fifth wheel kingpin release mechanism on the pulling vehicle.

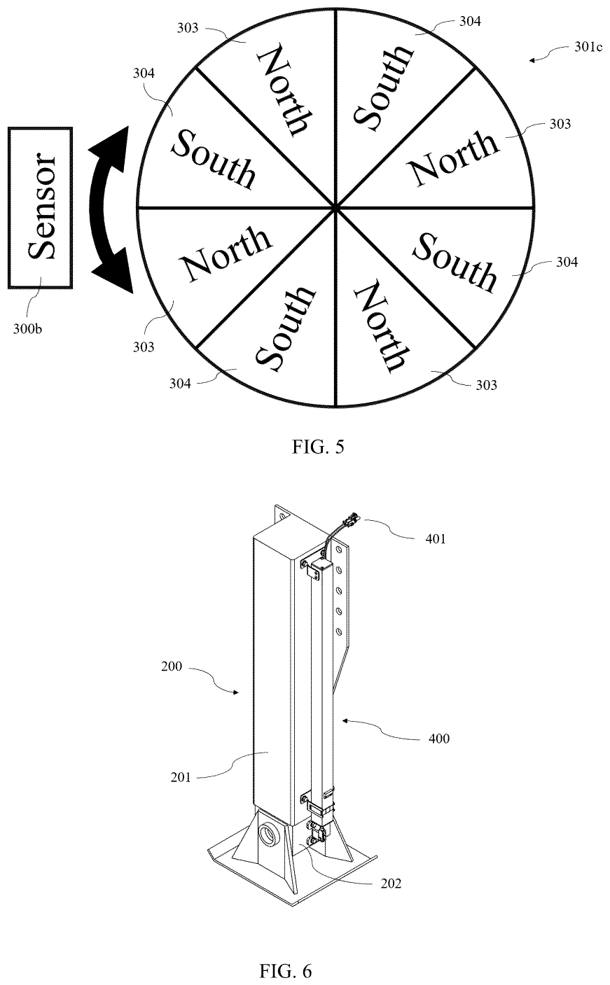

FIG. 5 provides a further alternative sensing method for the safety system 100. A continuous variable sensor 300b, such as a Hall effect sensor, may be used to detect an alternating polarity magnetic signal produced by the north polarity magnetic region 303 and the south polarity magnetic region 304. As the magnetic scale 301c rotates in proportion to the extension or retraction of the landing gear 200, the continuous variable sensor 300b will measure the relative strength and polarity of the alternating magnetic fields produced by the position of the magnetic scale 301c. The relative measurement scheme provided by the magnetic scale 301c may be converted to an absolute measurement scheme by changing the north polarity magnetic region 303 and the south polarity magnetic region 304 to an asymmetrical pattern. The sensing method illustrated in FIG. 4 may be applied to any shaft contained within the landing gear 200 without the use of a worm 111 and worm gear 112. Thus, in this embodiment, a circular measurement scale rotates in proportion to the linear extension of a landing gear so that one or more continuously variable sensor(s) detect an alternating polarity magnetic signal for measuring the landing gear position.

FIG. 6, shows another alternative embodiment of the safety system 400 installed on a landing gear 200 assembly. The upper tube 201 is mechanically fastened to the top of the safety system 400 and the lower tube 202 is mechanically fastened to the bottom of the safety system 400. As the landing gear 200 extends and retracts, the safety system 400 also extends and retracts. The safety system 400 utilizes this proportional relationship to sense the extended or retracted state of the landing gear 200 and transmits a corresponding signal to an electrical connector 401.

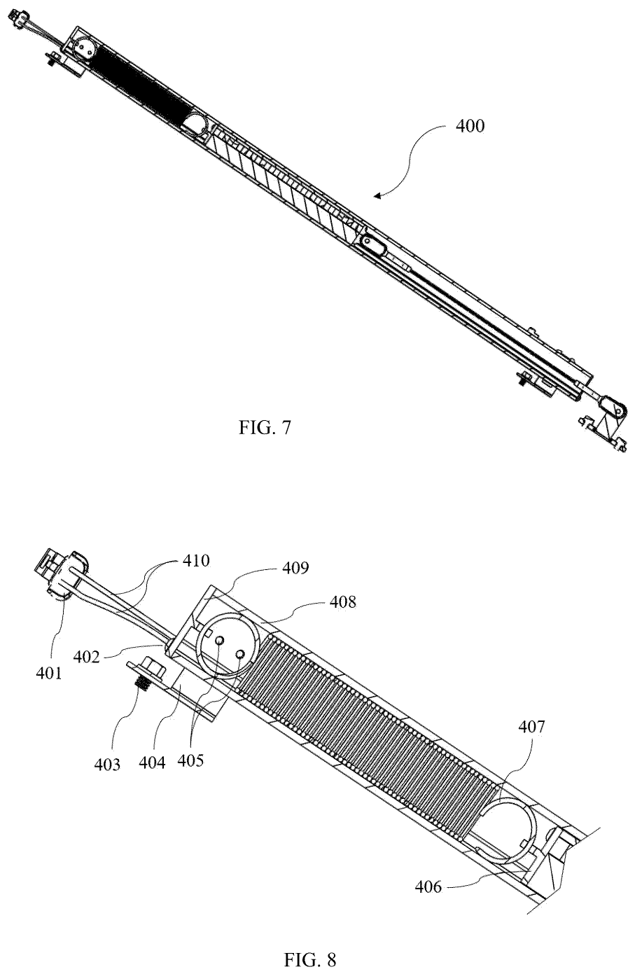

FIG. 7 illustrates the safety system 400 cross-sectioned with the landing gear 200 made to be transparent. FIG. 8 illustrates an enlarged view of the top of FIG. 7 to display internal components of the safety system 400. The safety system 400 consists of an outer tube 408 with a cap 409 fastened to the outer tube 408 by screws 402. The outer tube 408 is mounted to the upper tube 201 of the landing gear 200 by a bracket 404 and screws 403. Screws 405 fasten the outer tube 408 to the bracket 404 and a spring 407 creates a preloaded linear relationship between the cap 409 of the outer tube 408 and a second cap 406. As will be more completely described below wires 410 will conduct signals to an electrical connector 401 that indicate when the landing gear 200 is safely extended or retracted.

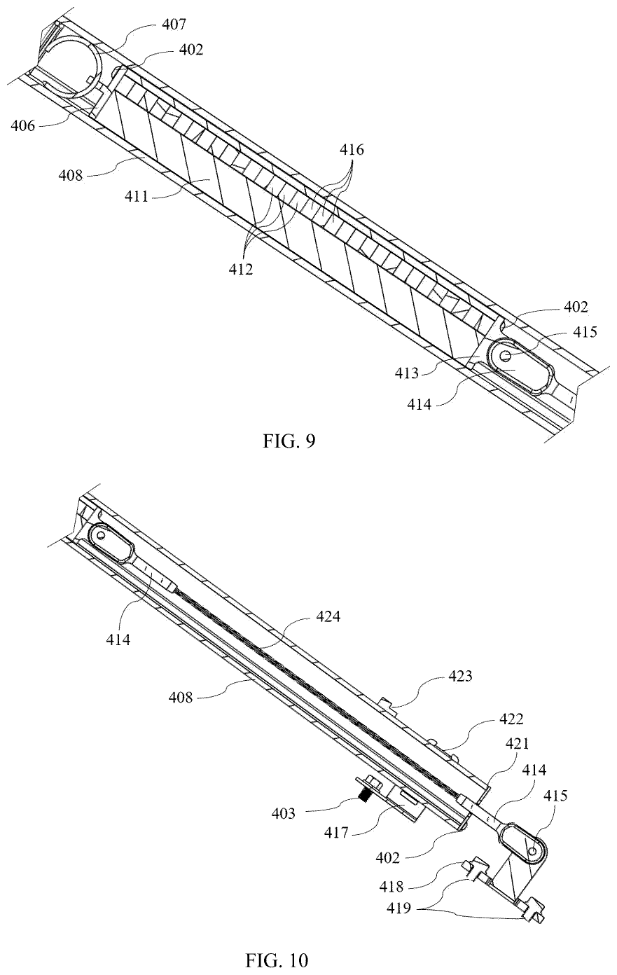

FIG. 9 illustrates an enlarged view of the center of FIG. 7 and further describes the internal components of the safety system 400. The suspending force of the spring 407 is transmitted through the second cap 406 to the inner tube 411 which is fastened to the second cap 406 by screws 402. The inner tube 411 carries magnets 412 and non-magnetic spacers 416 parallel with the axis of the outer tube 408. A third cap 413 is fastened to the inner tube 411 by screws 402 and a clevis 414 is connected to the third cap 413 by a pin 415.

FIG. 10 illustrates an enlarged view of the bottom of FIG. 7 to further display internal components of the safety system 400. The clevis 414 is swaged onto a cable 424 and a second clevis 414 is swaged on the opposite end of the cable 424. The second clevis 414 is connected to a bracket 418 by a pin 415 and the bracket 418 is fastened to the lower tube 202 by screws 419. The bottom of the outer tube 408 is fastened to the upper tube 201 by a metal band 422, a bracket 417, and screws 403. A dust cover 421 is also fastened to the outer tube 408 by screws 402 to prevent debris from entering the outer tube 408. As the lower tube 202 is extended relative to the upper tube 201 of the landing gear 200 assembly, the magnets 412 come into alignment with a sensor 423. The signal from the sensor 423 indicates when the landing gear 200 is extended.

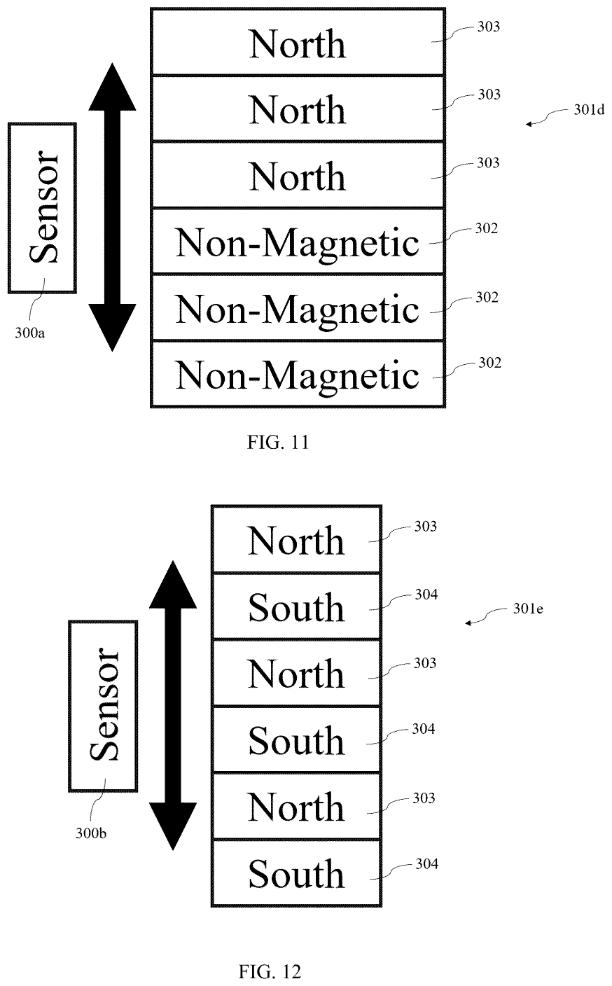

FIG. 11 illustrates the discrete sensing method as used by the safety system. A discrete sensor 300a, such as a reed switch, may be used to detect a fixed polarity magnetic signal produced by the north polarity magnetic region 303. The magnetic scale 301d moves linearly in proportion to the extension of the landing gear 200 such that full extension of the magnetic scale 301d is achieved between the fully retracted position and the fully extended position of the landing gear 200. The magnetic scale 301d has a non-magnetic region 302 indicating one state of either extension or retraction of the landing gear 200 and a north polarity magnetic region 303 indicating the opposite state. The north polarity magnetic region 303 may be increased or decrease in size by removing or adding segments to the north polarity magnetic region 303 to achieve different transition points between the two discrete states of the landing gear.

FIG. 12 provides an alternative sensing method for the safety system 400. A continuous variable sensor 300b, such as a Hall Effect sensor, may be used to detect an alternating polarity magnetic signal produced by the north polarity magnetic region 303 and the south polarity magnetic region 304. As the magnetic scale 301e moves linearly in proportion to the extension or retraction of the landing gear 200, the continuous variable sensor 300b will measure the relative strength and polarity of the alternating magnetic fields produced by the position of the magnetic scale 301e. The relative measurement scheme provided by the magnetic scale 301e may be converted to an absolute measurement scheme by changing the north polarity magnetic region 303 and the south polarity magnetic region 304 to an asymmetrical pattern.

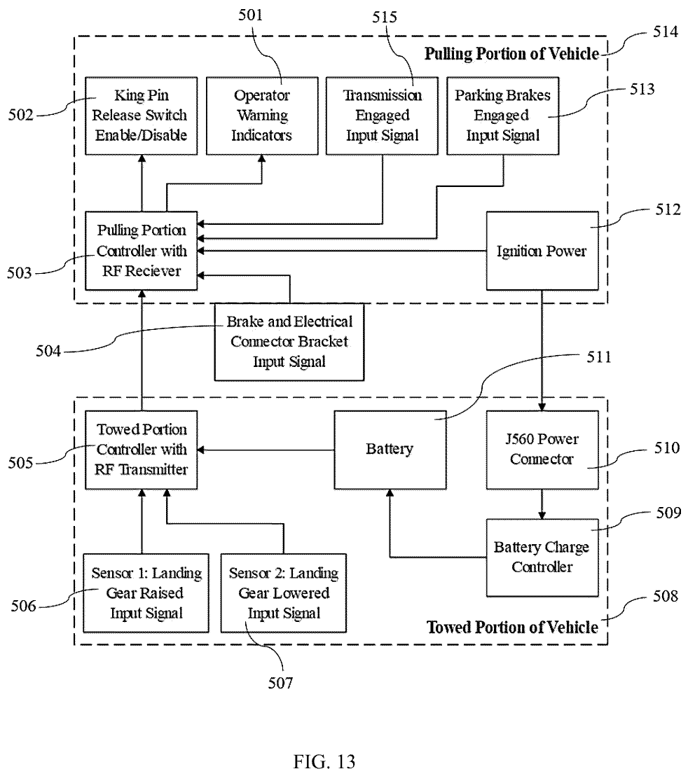

FIG. 13 is a diagram showing the landing gear 200 position and signals obtained by the sensing method described in FIG. 4. Those skilled in the art will further recognize that various methods may be utilized by a pulling portion controller 503 of the vehicle. A first sensor 506, which may be a reed switch, provides a signal to the towed portion controller 505, indicating that the landing gear 200 is in the raised position. A second sensor 507, which may be a reed switch, provides a signal to the towed portion controller 505, indicating the landing gear 200 is in the lowered position. In addition to the input signals from the first sensor 506 and second sensor 507, the towed portion controller 505 also receives ignition power 512 from a J560 power connector 510 and a battery 511 with a charge controller 509. The towed portion controller 505, includes a communications circuit that sends a signal to the pulling portion controller 503 through RF communication between the towed portion 508 and pulling portion 514 of the vehicle. In addition to the RF input signal from the towed portion controller 505, the pulling portion controller 503 also receives input signals from the transmission 515, parking brakes 513, and the bracket 504 for brake line connectors and electrical line connectors as well as ignition power 512. With all of the aforementioned inputs, the pulling portion controller 503 outputs warning indicators 501 to annunciate to the vehicle operator when an unsafe condition exists and under some conditions, disables the king pin release switch 502. Those skilled in the art will further recognize that future vehicles include features enabling an autonomous release of the king pin. Thus, the present invention may also disable this autonomous release functionality.

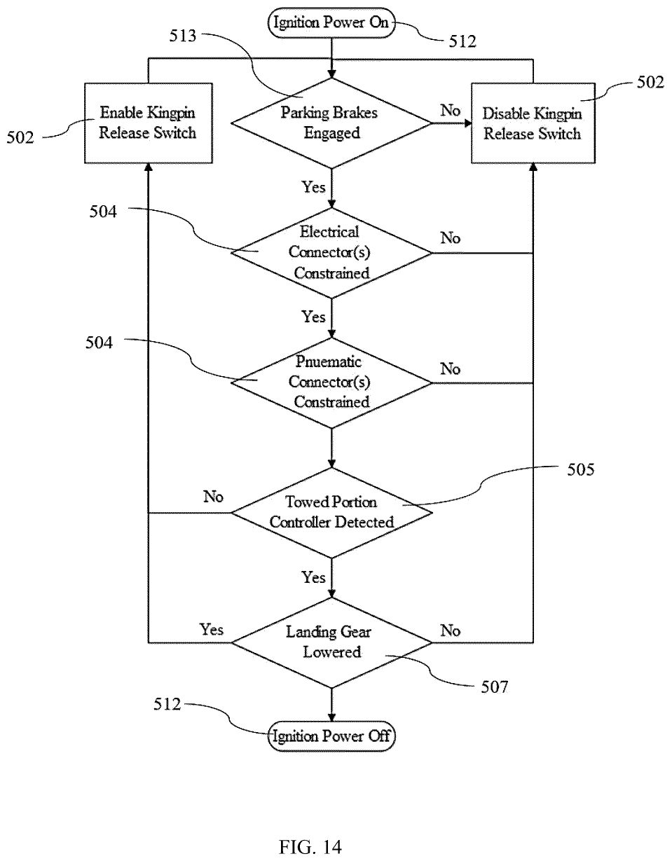

FIG. 14 illustrates a flow chart describing the process by which the pulling portion controller 503 evaluates input signals to determine required output signals for safe vehicle operation. Upon receiving ignition power 512, the pulling portion controller 503 will determine if the vehicles parking brakes 513 are engaged, the electrical line connectors are stowed in their bracket 504 and brake line connectors are stowed in their bracket 504. If these conditions are met, the pulling portion controller 503 will check for the presence of a towed portion controller 505. If a towed portion controller 505 is equipped, the pulling portion controller 503 will determine if the second sensor 507 indicates that the landing gear is lowered. When all conditions are met, the pulling portion controller 503 allows the operator to release the king pin of the towed portion 508 of the vehicle. If any one of the conditions are not met, the pulling portion controller 503 will disable the king pin release switch 502. Furthermore, the pulling portion controller 503 will provide a warning indicator 501 if the operator attempts to use the disabled king pin release switch 502.

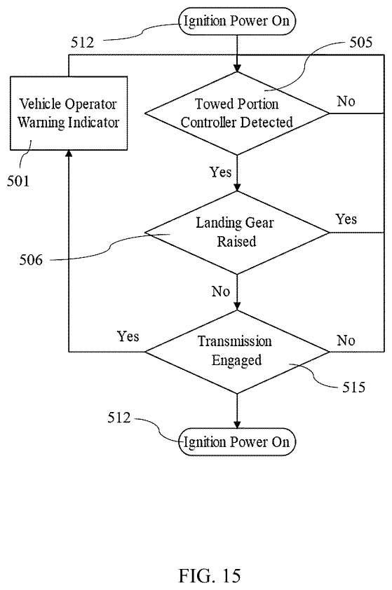

FIG. 15 illustrates a flow chart describing the process by which the pulling portion controller 503 further evaluates input signals to determine what output signals are required for safe operation of the vehicle. Upon receiving ignition power 512, the pulling portion controller 503 will check for the presence of a towed portion controller 505. Assuming the vehicle is equipped with a towed portion controller 505, the pulling portion controller 503 will check the status of the first sensor 506 to determine if the landing gear 200 is not raised. If the operator attempts to engage the transmission 515 while the landing gear 200 is not in the raised position, the pulling portion controller will provide a warning indicator 501 to alert the driver.

### Operation

In operation, the procedure for decoupling the towed portion from the pulling portion of a vehicle with the safety system is very similar to the procedure for decoupling without the safety system. The operator must bring the pulling portion to a complete stop, set the parking brake, exit the vehicle, extend the landing gear, remove the electrical line connector and the pneumatic line connectors from the towed portion, insert and thereby constrain the electrical line connector and the pneumatic line connectors in the respective receptacles, of the bracket assembly, and release the kingpin from the fifth wheel.

The difference in operation is that the kingpin release switch will be disabled when the landing gear is not extended. In some embodiments, it will also be disabled is if the electrical line connectors or the pneumatic line connectors are not constrained properly in their bracket assembly. In still other embodiments, it may be disabled when the parking brake(s) are not engaged. In that case, when the operator re-enters the cab of the vehicle, and presses the kingpin release switch, rather than actuating the kingpin release mechanism with the solenoid, the buzzer will produce a warning tone to alert the operator to a safety hazard.

After successfully decoupling the towed portion from the pulling portion of the vehicle, the operator will subsequently couple to a new towed portion. When the operator couples a new towed portion to the pulling portion of the vehicle, the buzzer will alert the operator to an unsafe condition if the landing gear remains extended when the operator releases the parking brakes or puts the transmission into gear. This warning indicator will provide an alert to the operator for a set time period.

Thus, embodiments of the present invention are directed to a semi-trailer landing gear safety system that consists of both mechanical and electrical hardware whose purpose is to detect unsafe operating conditions. These conditions exist in towing arrangement using a pulling portion and a towed portion, such as a commercial tractor and trailer. The system prohibits improper vehicle disconnection procedures and notifies the vehicle operator of unsafe landing gear conditions that must be rectified. More specifically, a vehicle with the electronic safety system, monitors safety conditions of the vehicle while the operator is unable to do so. The system includes a measurement apparatus that is configured to mount on the towed portion of the vehicle to measure the extended or retracted position of the towed portion's landing gear. The system also includes a controller located on the “pulling portion” or vehicle to evaluate the landing gear position signal sent from the “towed portion” or semi-trailer. The vehicle controller alerts the operator when the landing gear on the semi-trailer is in an unsafe position and may disable the fifth wheel release function until the unsafe condition is rectified.

More specifically, the extended or retracted position of the landing gear may be sensed by a proximity switch or other type of sensor and the controller may communicate the position of the landing gear to the pulling portion of the vehicle by wired methods such as ISO3731 and CAN-bus communication (controller area network bus communication). Alternatively, wireless communication methods such as RF communication (radio frequency communication) and satellite telematics may also be used. The control circuit may be powered by the pulling portion using a cable such as a J560 cable or an ISO3731 cable. Sensors that detect discrete on and off signals, such as one or more reed switches, may be used to measure the landing gear position or sensors that detect continuous variable signals such as one or more Hall effect sensors may be used. Other embodiments may include similar sensing methods that use other physical or electrical properties such as capacitive, inductive, or optical sensors with scales that use corresponding properties.

Sensors that detect discrete signals may require the use of a discrete measurement scale and sensors that detect continuously variable signals may require the use of a continuously variable measurement scale. For example, a measurement scale for a reed switch may possess a non-magnetic region to indicate one discrete state and a magnetic region of fixed polarity to indicate a second discrete state. An example of a measurement scale for a Hall effect sensor may possess a series of alternating polarity magnetic regions and the relative strength of each magnetic pole may indicate the position of the scale relative to the sensor. The measurement scales may also possess features to indicate a home position for calibration or the measurement scale may also possess a signal pattern that produces an absolute measurement. Those skilled in the art will recognize that the measurement scales may be linear scales, circular scales, or any other geometrical configuration that may correlate with the position of the landing gear. The measurement scales may possess adjustable transition points to denote changes between extended or retracted states of the landing for a given application. The extended or retracted states may be used by a control system of the vehicle. Thus, the control system can prevent decoupling of the pulling portion from the towed portion when the landing gear is retracted and/or it can prevent movement of the pulling portion when the landing gear is extended.

Components of the landing gear position sensing apparatus may be made of non-ferrous material such as aluminum or 300 series austenitic stainless-steel to prevent interference with the magnetic field of permanent magnets that may be contained within the sensing apparatus. Non-ferrous materials such as nylon or acetal may be used for gears contained within the sensing apparatus for the same reason. However, acetal gears may be preferred for their dimensional stability in wet environments. Components of the landing gear position measuring apparatus may also be electrically insulated from the vehicle to preserve signal integrity. Insulating the sensing apparatus from a poorly grounded vehicle may prevent stray currents from inducing magnetic fields within metal components of the measuring apparatus.

A super capacitor, battery pack with charge control circuitry, or another form of energy storage may be used to maintain power to the towed portion of the vehicle after a J560 cable, an ISO3731 cable or another external power source is disconnected from the towed portion. Communication between the towed portion and the pulling portion may also be maintained through wireless communication methods such as RF communication. RF Communication would require the addition of a controller on the towed portion of the vehicle to communicate wirelessly with the controller on the pulling portion. The towed portion controller may enter a powered down state to preserve stored energy when the pulling portion controller transmits a signal to indicate when communication is no longer required. Alternatively, an idle timer within the towed portion controller may also power down the towed portion controller to preserve stored energy.

Undesired wireless communication between adjacent vehicles may be mitigated by using directional RF antennas so that communication only occurs between the two vehicle portions when they are oriented properly for coupling or decoupling. Signal shielding may also be used to the left and right of the vehicle to prevent undesired communication between adjacent vehicles. Signal shielding methods may be applied to the pulling portion controller, the towed portion controller, or both to reject signals transmitted by adjacent vehicles.

The landing gear position signal may be evaluated alone or in combination with other safety signals to facilitate safe operation of the vehicle. Other safety signals evaluated by the pulling portion controller may include the position of electrical power lines and pneumatic brake lines to prevent damage during decoupling of the pulling and towed portions of the vehicle.

Further evaluation of safety signals may include the parking brake status signal and the transmission status signal. When any one of these signals indicate that an unsafe condition exists, the operator will be notified by an audible or visual indicator. The pneumatic fifth wheel release function may also be disabled until the unsafe conditions have been rectified.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

The invention is defined solely by the appended claims including any amendments made during the pendency of this application and all equivalents of those claims as issued.

1. A semi-trailer landing gear safety system comprising:
at least one discrete sensor;
a circular measurement scale having a plurality of magnetic and non-magnetic regions;
a controller located in a pulling vehicle; and
wherein the circular measurement scale rotates in proportion to the linear extension of landing gear such that the at least one discrete sensor detects a fixed polarity magnetic signal for measuring the landing gear position.

2. The semi-trailer landing gear safety system as in claim 1, wherein the at least one discrete sensor is a reed switch.

3. The semi-trailer landing gear safety system as in claim 1, wherein a first half of the circular measurement scale is magnetic and a second half of the circular measurement scale is non-magnetic.

4. The semi-trailer landing gear safety system as in claim 1, wherein a first portion of a magnetic region on the circular measurement scale passes in front of a first discrete sensor when the landing gear is retracted and a second portion of the magnetic region passes in front of a second discrete sensor when the landing gear is extended.

5. The semi-trailer landing gear safety system as in claim 4, wherein the system detects landing gear transitioning from extended to a retracted position when a non-magnetic region passes in front of the first discrete sensor and second discrete sensor.

6. The semi-trailer landing gear safety system as in claim 1, wherein the safety system indicates when the landing gear has been extended sufficiently for a semi-trailer to be safely released from the pulling vehicle.

7. The semi-trailer landing gear safety system as in claim 1, wherein the safety system indicates whether the landing gear on the semi-trailer has been retracted sufficiently for the vehicle to be safely moved.

8. The semi-trailer landing gear safety system as in claim 1, wherein the safety system controls operation of a fifth wheel kingpin release mechanism on the pulling vehicle.

9. The semi-trailer landing gear safety system as in claim 8, wherein the release mechanism is enabled when the landing gear is in a safe position for allowing the pulling vehicle released and disabled when the landing gear is in an unsafe position to prevent release of the pulling vehicle.

10. A semi-trailer landing gear safety system comprising:
at least one circular measurement scale having a plurality of magnetic regions with alternating polarity;
at least one continuous variable sensor;
a controller located in a pulling vehicle; and
wherein the circular measurement scale rotates in proportion to the linear extension of a landing gear such that the at least one continuous variable sensor detects an alternating polarity magnetic signal for measuring the landing gear position.

11. The semi-trailer landing gear safety system as in claim 10, wherein the at least one continuous variable sensor measures the relative strength and polarity of alternating magnetic fields produced by the position of the circular measurement scale.

12. The semi-trailer landing gear safety system as in claim 10, wherein the continuous variable senor is a Hall effect sensor.

13. The semi-trailer landing gear safety system as in claim 10, wherein the safety system indicates when the landing gear has been extended sufficiently for the semi-trailer to be safely released from a pulling vehicle.

14. The semi-trailer landing gear safety system as in claim 10, wherein the safety system indicates whether the landing gear on the semi-trailer has been retracted sufficiently for a pulling vehicle to be safely moved.

15. The semi-trailer landing gear safety system as in claim 10, wherein the safety system controls operation of a fifth wheel kingpin release mechanism on a pulling vehicle.

16. The semi-trailer landing gear safety system as in claim 15, wherein the release mechanism is enabled when the landing gear is in a safe position for allowing release from the pulling vehicle, and is disabled when the landing gear is in an unsafe position preventing release from the pulling vehicle.

17. A semi-trailer landing gear safety system comprising:
a measurement scale;
at least one sensor; and
wherein the measurement scale moves relative to the at least one sensor in proportion to an extension of a landing gear on a semi-trailer for measuring the landing gear position.

18. The semi-trailer landing gear safety system as in claim 17, wherein the measurement scale is linear.

19. The semi-trailer landing gear safety system as in claim 17, wherein the at least one sensor detects a discrete on or off signal from the measurement scale.

20. The semi-trailer landing gear safety system as in claim 17, wherein the at least one sensor detects a continuously variable signal from the measurement scale.

21. The semi-trailer landing gear safety system as in claim 17, wherein the measurement scale is a circular measurement scale.

22. The semi-trailer landing gear safety system as in claim 17, wherein the safety system indicates when the landing gear has been extended sufficiently for a semi-trailer to be safely released from a pulling vehicle.

23. The semi-trailer landing gear safety system as in claim 17, wherein the safety system indicates whether the landing gear on the semi-trailer has been retracted sufficiently for the vehicle to be safely moved.

24. The semi-trailer landing gear safety system as in claim 17, further comprising:
a communication circuit for transmitting a safety status signal measured by the at least one sensor to the control circuit of a fifth wheel vehicle.

25. The semi-trailer landing gear safety system as in claim 17, wherein the communications circuit controls operation of a fifth wheel kingpin release mechanism on a pulling vehicle such that the release mechanism is enabled when the landing gear is in a safe position for release from the vehicle and is disabled when the landing gear is in an unsafe position for release from the vehicle.

26. The semi-trailer landing gear safety system as in claim 17, further comprising:
an energy storage device for providing power to the safety system after the semi-trailer has been disconnected from an external power source, such that the communication circuit continues to function in the absence of the external power source.

27. The semi-trailer landing gear safety system as in claim 24, wherein the communication circuit includes a controller located on the fifth wheel vehicle for communicating wirelessly with a pulling portion of the fifth wheel vehicle.

28. The semi-trailer landing gear safety system as in claim 27, wherein the communications circuit in the semi-trailer includes a directional RF antenna on the vehicle for preventing reception by adjacent vehicles.

29. The semi-trailer landing gear safety system as in claim 27, wherein the controller in the vehicle includes a circuit for disabling a fifth wheel release function of the vehicle when the landing gear of the towed portion is retracted.

30. The semi-trailer landing gear safety system as in claim 17, further comprising:
an indicator for annunciating to the vehicle operator when the landing gear of the semi-trailer is retracted if a release switch is actuated.

31. The semi-trailer landing gear safety system as in claim 17, further comprising:
an indicator for annunciating to the operator when the landing gear on semi-trailer is extended and the vehicle transmission is in gear.
